(19) United States
(12) Patent Application Publication
(10) Pub. No.: US 2014/0173146 A1
(43) Pub. Date: Jun. 19, 2014

(54) HARD DISK DRIVE MODULE HAVING USB INTERFACE AND ELECTRONIC DEVICE USING THE HARD DISK DRIVE MODULE

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventors: KANG WU, Shenzhen (CN); BO TIAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/097,244

(22) Filed: Dec. 5, 2013

(30) Foreign Application Priority Data
Dec. 19, 2012 (CN) 2012105534453

(51) Int. Cl. G06F 3/06

(52) U.S. Cl. CPC G06F 3/0614; G06F 3/0655; G06F 3/0674
USPC 710/74

(57) ABSTRACT

A hard disk drive module includes a hard disk drive, a bracket, a hard disk drive backplane, and a USB interface unit. The bracket supports the hard disk drive. The hard disk drive backplane is electrically connected to the hard disk drive. The USB interface unit includes a USB interface circuit arranged on the bracket and a cable connected between the USB interface circuit and the hard disk drive backplane.

### BACKGROUND

1. Technical Field

The present disclosure relates to a hard disk drive module, particularly to a hard disk drive module having a USB interface, and further relates to an electronic device using the hard disk drive module.

2. Description of Related Art

Electronic devices, such as computers and servers include a plurality of USB interfaces to connect between peripheral devices. However, to minimize a size of the electronic device, only a few USB interfaces are arranged on the electronic device, which may be insufficient for the user.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an isometric view of a hard disk drive module having a USB interface unit according to one embodiment.

FIG. 2 is a schematic circuitry diagram of the USB interface unit of the hard disk drive module of FIG. 1.

### DETAILED DESCRIPTION

Reference will be made to the drawings to describe various embodiments.

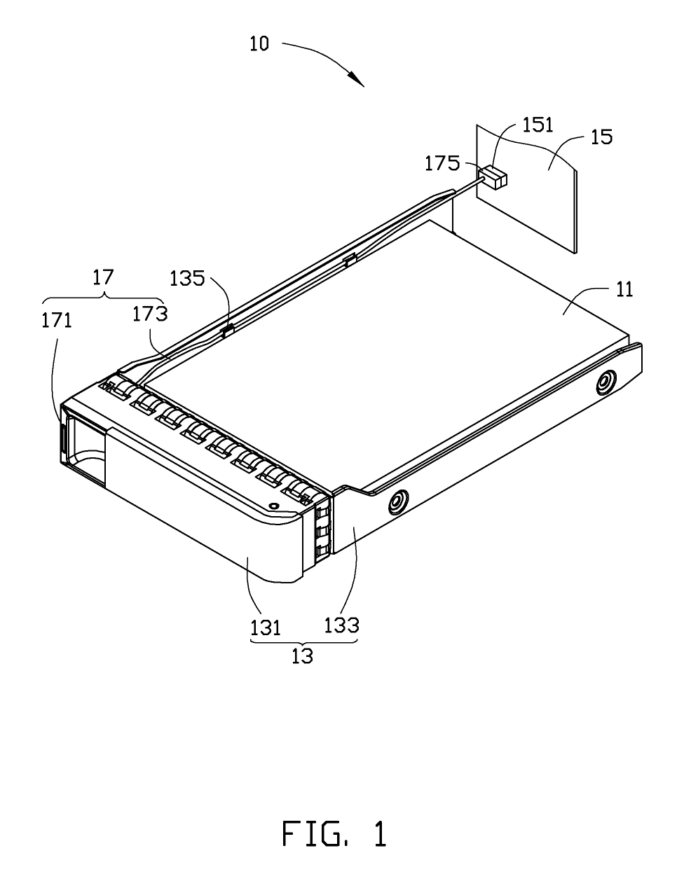

FIG. 1 shows an isometric view of a hard disk drive module 10. The hard disk drive module 10 is arranged within an electronic device, such as a computer, server, or the like. The electronic device can include a plurality of hard disk drive modules. The hard disk drive module 10 includes a hard disk drive 11, a bracket 13, a hard disk drive backplane 15, and a universal serial bus (USB) interface unit 17.

The bracket 13 supports and fixes the hard disk drive 11 in the electronic device. A cross view of the bracket 13 is U-shaped, and the bracket 13 comprises a main body 131 and two arms 133 extending outwardly from opposite ends of the main body 131. The two arms 133 are substantially parallel to each other, and substantially perpendicular to the main body 131. The hard disk drive 11 is sandwiched between the two arms 133. The bracket 13 further includes a plurality of hooks 135 protruding outwardly from an inner surface of each arm 133.

The hard disk drive backplane 15 is electrically connected to the hard disk drive 11 for data transmission.

The USB interface unit 17 includes a USB interface circuit 171 and a cable 173. The USB interface 171 is arranged on the main body 131. The cable 173 connects between the USB interface circuit 171 and the hard disk drive backplane 15. The USB interface circuit 171 is configured to electrically connect to peripheral devices, such as keyboards and mouse.

One end of the cable 173 is electrically connected to the USB interface circuit 171, and another end of the cable 173 includes a connector 175 to connect to a slot 151 arranged on the hard disk drive backplane 15. The cable 173 is fixed by the hooks 135 of the bracket 13.

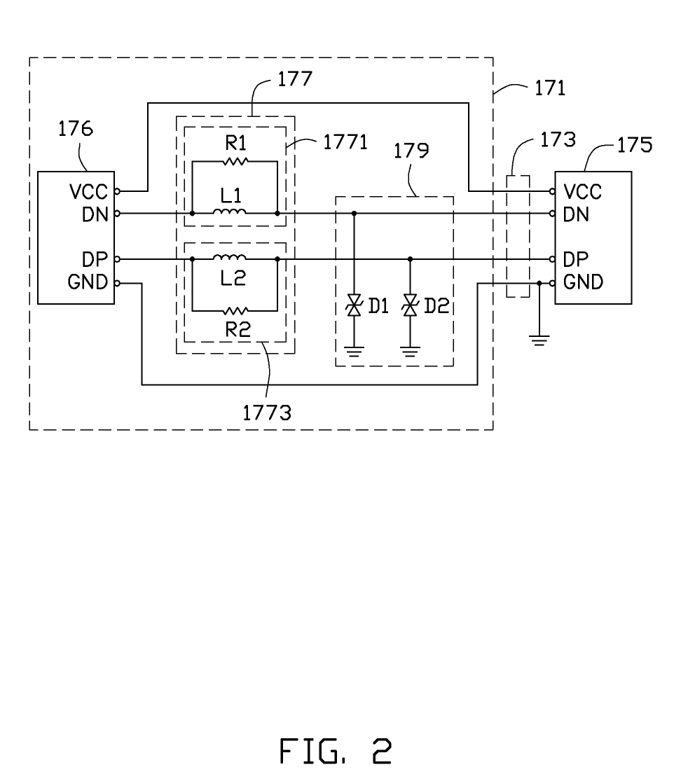

FIG. 2 shows a schematic circuitry diagram of the USB interface unit 17. The USB interface unit 17 includes a USB interface 176, a filtering unit 177, and an electrostatic defending unit 179. The USB interface 176 includes a power pin VCC, a ground pin GND, and two data pins DN and DP. The filtering unit 177 filters signals transmitted by the two data pins DN and DP to improve quality of the signals. The electrostatic defending unit 179 prevents static electricity from damaging the peripheral device connected to the USB interface 176. In the embodiment, the filtering unit 177 and the electrostatic defending unit 179 are integrated in the USB interface 176.

In the embodiment, the connector 175 includes four pins corresponding to the USB interface 176.

The filtering unit 177 includes a first filtering circuit 1771 and a second filtering circuit 1773. The first filtering circuit 1771 is electrically connected between the data pin DN and the connector 175. The second filtering circuit 1773 is electrically connected between the data pin DP and the connector 175. The first filtering circuit 1771 includes a first resistor R1 and a first inductor L1 which are connected in parallel. The second filtering circuit 1773 includes a second resistor R2 and a second inductor L2 which are connected in parallel.

The electrostatic defending unit 179 includes a first electrostatic protector D1 and a second electrostatic protector D2. The first inductor L1 is grounded via the first electrostatic protector D1. The second inductor L2 is grounded via the second electrostatic protector D2.

The USB interface circuit is arranged on the bracket of the hard disk drive module, thus it does not occupy a space of the casing panel and USB interfaces can be arranged for the electronic device. Further, the USB interface circuit improves the quality of the signals transmitted by the USB interface.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A hard disk drive module, comprising:
a hard disk drive;
a bracket supporting the hard disk drive;
a hard disk drive backplane electrically connected to the hard disk drive; and
a USB interface unit comprising a USB interface circuit arranged on the bracket and a cable connected between the USB interface circuit and the hard disk drive backplane.

2. The hard disk drive module of claim 1, wherein one end of the cable is electrically connected to the USB interface circuit, and another end of the cable comprises a connector to connect to a slot arranged on the hard disk drive backplane.

3. The hard disk drive module of claim 2, wherein the USB interface unit comprises a USB interface which comprises a power pin, a ground pin, and two data pins.

4. The hard disk drive module of claim 3, wherein the USB interface circuit comprises a filtering unit filtering signals transmitted by the two data pins and an electrostatic defending unit preventing static electricity from damaging a peripheral device connected to the USB interface.

5. The hard disk drive module of claim 4, wherein the filtering unit comprises a first filtering circuit electrically connected between one of the two data pins and the connector and a second filtering circuit electrically connected between the other of the two data pins and the connector.

6. The hard disk drive module of claim 5, wherein the first filtering circuit comprises a first resistor and a first inductor connected in parallel, and the second filtering circuit comprises a second resistor and a second inductor connected in parallel.

7. The hard disk drive module of claim 6, wherein the electrostatic defending unit comprises a first electrostatic protector and a second electrostatic protector, the first inductor is grounded via the first electrostatic protector, and the second inductor is grounded via the second electrostatic protector.

8. The hard disk drive module of claim 1, wherein the bracket is U-shaped, and the bracket comprises a main body and two arms extending outwardly from opposite ends of the main body, the two arms are substantially parallel to each other and substantially perpendicular to the main body, and the hard disk drive is between the two arms.

9. The hard disk drive module of claim 8, wherein the bracket further comprises a plurality of hooks protruding from an inner surface of one of the arms to fix the cable on the bracket.

10. A hard disk drive module, comprising:
a hard disk drive;
a bracket supporting the hard disk drive;
a hard disk drive backplane electrically connected to the hard disk drive; and
a USB interface unit comprising a USB interface circuit arranged on the bracket and a cable, wherein one end of the cable is electrically connected to the USB interface circuit, and the other end of the cable is electrically connected to the hard disk drive backplane.

11. The hard disk drive module of claim 10, wherein the other end of the cable comprises a connector to connect to a slot arranged on the hard disk drive backplane.

12. The hard disk drive module of claim 11, wherein the USB interface unit comprises a USB interface which comprises a power pin, a ground pin, and two data pins.

13. The hard disk drive module of claim 12, wherein the USB interface circuit comprises a filtering unit filtering a signal transmitted by the two data pins and an electrostatic defending unit preventing electrostatic damage to a peripheral device connected to the USB interface.

14. The hard disk drive module of claim 13, wherein the filtering unit comprises a first filtering circuit electrically connected between one of the data pins and the connector, and a second filtering circuit electrically connected between the other of the data pins and the connector.

15. The hard disk drive module of claim 14, wherein the first filtering circuit comprises a first resistor and a first inductor connected in parallel, and the second filtering circuit comprises a second resistor and a second inductor connected in parallel.

16. The hard disk drive module of claim 15, wherein the electrostatic defending unit comprises a first electrostatic protector and a second electrostatic protector, the first inductor is grounded via the first electrostatic protector, and the second inductor is grounded via the second electrostatic protector.

17. The hard disk drive module of claim 10, wherein the bracket is U-shaped, and the bracket comprises a main body and two arms extending outwardly from opposite ends of the main body, the two arms are substantially parallel to each other and substantially perpendicular to the main body, and the hard disk drive is between the two arms.

18. The hard disk drive module of claim 17, wherein the bracket further comprises a plurality of hooks protruding from an inner surface of one of the arms, and the cable is fixed on the hooks of the bracket.

19. An electronic device, comprising a plurality of hard disk drive modules, each hard disk drive module comprising a hard disk drive, a bracket supporting the hard disk drive, a hard disk drive backplane electrically connected to the hard disk drive, and a USB interface unit comprising a USB interface circuit arranged on the bracket and a cable connected between the USB interface circuit and the hard disk drive backplane.
